(19) United States
(12) Patent Application Publication
(10) Pub. No.: US 2019/0207303 A1
(43) Pub. Date: Jul. 4, 2019

(54) AN ANTENNA FOR A COMMUNICATIONS SYSTEM

(71) Applicant: Cambridge Communication Systems Limited, Cambridge (GB)

(72) Inventors: John David Porter, Cambridge (GB); Daiqing Li, Cambridge (GB); Martin Prescott, Cambridge (GB)

(73) Assignee: Cambridge Communication Systems Limited, Cambridge (GB)

(21) Appl. No.: 16/314,259

(22) PCT Filed: Jun. 30, 2017
(86) PCT No.: PCT/GB2017/051944

§ 371 Date: Dec. 28, 2018

(30) Foreign Application Priority Data
Jul. 1, 2016 (GB) 1611552.9
Jul. 1, 2016 (GB) 1611558.6

(51) Int. Cl. H01Q 1/42; H01Q 15/08; H01Q 15/10; H01Q 19/06; H01Q 21/06; H01Q 21/20

(52) U.S. Cl. CPC H01Q 1/42; H01Q 15/08; H01Q 21/20; H01Q 19/06; H01Q 21/064; H01Q 15/10

(57) ABSTRACT

A node 100 for a communications system comprising a plurality of nodes is disclosed. The node 100 comprises a plurality of antennas each configured to transmit and/or receive a beam for communications with other nodes of a communications system. The at least one beam deflector is located in a housing 104,106 detachably attached to an external portion of the node 100. The or each beam deflector is located and arranged to deflect a beam transmitted and/or received at one of the plurality of antennas.

### FIELD OF THE INVENTION

This invention relates to an antenna for a communications system.

### BACKGROUND OF THE INVENTION

Mobile telephones are virtually ubiquitous and are commonly carried by their users at all times. Such telephones are traditionally used for making and receiving telephone calls and sending and receiving short messages (SMS). The more advanced modern phones, often referred to as smartphones, have further provision for advanced data services such as the sending and receiving of emails and the accessing of wide area networks such as the Internet. Advances in wireless technology have resulted in a progression in the use of wireless standards from the original analogue service, through GSM, 3G, 4G to emerging 5G and related standards. These standards have led to the development of ever more capable handheld devices.

In conjunction with the advances in technology required of the handset, the increased usage of mobile phones and the more data intensive services that are now commonly used has led to an increased load on the hardware providing the wireless service. A mobile phone wireless network has been typically configured as a set of wireless base stations that cover one or more cells that are then connected into a wired backbone telecommunication service. As more and more demand is placed on the wireless network, the base stations are cited closer together with smaller cells. In urban areas in particular, given the high density of users, the locating of base stations is becoming a significant technical problem, given that a base station must have a connection into the wired backbone telecommunication service. In order to reduce the street works needed to deploy high density base stations, a wireless backhaul link with a network of nodes has been devised. UK patent application with publication No. GB2512858 describes the antenna arrangement of a wireless node of this arrangement. The node provides a high capacity wireless backhaul link directly or via one or more similar nodes to a point where wired connection can more easily be provided. The wired connection to the backbone telecommunications service may be over copper or optical fibre.

An important aspect of almost all wireless backhaul links is the use of directional antennas. All directional antennas work by focussing the radiation in one, desired, direction and reducing radiation in other undesired directions. The gain of the antenna is a direct factor of the ratio of the stereo angle served by the main beam to the full surface of a sphere. The advantages of a directional antenna are an increase in the level of the wanted signal (antenna gain) and a reduction in interference to other off-beam links. The narrower the beam, the higher will be the gain. The increased signal level resulting from the antenna gain delivers greater range, link bandwidth or both. The disadvantage of a directional antenna is the need to ensure that it is pointing in the right direction. Conventional point-to-point microwave backhaul links rely on manual alignment of individual antennas for each link at the time of link installation. This adds time and cost to the installation process and also is at risk of degradation or lose of the communications link if the equipment moves, for example due to swaying of the lamppost on which the equipment is mounted. The solution described in UK patent application with publication No. GB2512858 uses a multiplicity of switched narrow antennas to cover an angle of up to 270 degrees around a node. This retains the advantage of directional antennas but eliminates the need for manual alignment. An algorithm within the system selects the optimum antenna for each link. Adequate gain is achieved by narrowing the antenna pattern as much as possible in both vertical and horizontal planes. FIG. 1 shows the internal antenna structure of the node or unit 10 described in UK patent application with publication No. GB2512858 with its radome removed. The antennas 12,14 (in use, within a radome) of the wireless node are arranged in two layers (reference numerals are only used to highlight some of the antennas in Figure for clarity) with alternate antennas on upper layers (antennas 12) and lower layers (antennas 14). The provision of the antennas in two different horizontal planes means that antennas can be selected in a transmitting mode and a receiving mode so that the likelihood of destructive interference from a reflected signal path is reduced.

FIG. 2 shows the node 10 of FIG. 1 with the radome 16 in place that conceals and provides protection to the antenna structure (that is not visible in FIG. 2).

This solution works well when all of the nodes 10 in a network lie approximately in the same plane but is not ideal if one or more nodes in the network need to lie significantly outside the plane covered by the standard antenna patterns. Tilting the unit to elevate the beam of an antenna would have the disadvantage of tilting up or down the beam of other antennas of the node. This is illustrated with reference to FIG. 3 by way of example. FIG. 3 shows a wireless node 10 mounted on a lamp-post 20 that needs to communicate with a second wireless node 10′ mounted on the roof of a building 22. The normal horizontal beam 24 of the wireless node's antenna is too narrow to give good coverage of the rooftop. Furthermore, antenna elements pointing even partially out of the plane of tilt have their polarisation made, to some extent, non-vertical at some cost to link budget due to polarisation mismatch. An arrangement is needed to divert the beam of the antenna in a new direction 26 to effectively reach the rooftop node 10′.

### BRIEF SUMMARY OF THE INVENTION

The invention in its various aspects is defined in the independent claims below to which reference should now be made. Advantageous features are set forth in the dependent claims.

The inventors of the present patent application have appreciated that by providing a beam deflector located and arranged to deflect a beam transmitted and/or received at the antenna that the need described above is met and the problems of the prior art are overcome. Embodiments of the invention are also easy and cheap to manufacture; easily fixed or attached, removed, or changed on a standard node in the field. Embodiments provide a flexible and cost effective solution.

Arrangements are described in more detail below and take the form of a node for a communications system comprising a plurality of nodes. The node comprises a plurality of antennas each configured to transmit and/or receive a beam for communications with other nodes of a communications system. The at least one beam deflector is located in a housing detachably attached to an external portion of the node. The or each beam deflector is located and arranged to deflect a beam transmitted and/or received at one of the plurality of antennas.

Embodiments of this arrangement are easy to deploy as an optional post-manufacturing solution within a compact yet cost effective physical package that is readily mass-produced. Isolation between transmission paths is retained. Poor isolation between neighbouring antenna elements provides an undesirable interference coupling path as a non-selected antenna picks up interference which is significantly off-beam from the selected antenna, thereby subverting the spatial selectivity of the directional antenna element design. Beam deflectors or lenses of embodiments of the present invention, located in front of an antenna element have little impact on isolation and desired beam shape of the antenna element.

Embodiments of the node include a radome that is sealed and, advantageously, the beam deflector does not interrupt the seal provided by the radome or its structural integrity. Embodiments of the node are also resilient to extreme environmental conditions such as extreme temperatures (for example, −45° C. to 55° C.), ice, vibration, water/humidity, and stability when exposed to ultraviolet light; as well as flammability.

The beam deflector described is amenable for low cost high volume manufacture, by for example, being suitable for injection moulding or extrusion, with low-complexity tooling; readily available and low-cost feedstocks; simple and clear assembly, with low numbers of individual parts. The beam deflector only needs to be fitted or attached when required in the field and not at manufacture.

In the arrangements described, an external lens or beam deflector is simply added to the desired antenna element positions that provides a low-cost way of using a known wireless node and re-directing selected antenna beams such that the known node can be deployed in normal fashion (upright) and still cover far nodes at a variety of large and small elevation angles. This can be simply and clearly indicated on a deployment plan, for example, “fit external lens of type B to position X on the radome, in +ve/−ve orientation”. This is especially important because, as described above, nodes are typically located in hard to access areas such as on lamp posts and on building roofs that are accessed by ladder. Deployment can be by low-skilled users or workers.

Broadly, a wireless communications system comprising a directional antenna, a removable beam deflecting device and a means of attachment of said beam deflecting device to said antenna is provided. The beam deflecting device or diverting means may comprise one or more dielectric lenses. The means of attachment may comprise a clip-on means. The clip-on means may be provided by using the natural flexibility of the material from which it is constructed. Nonetheless, the means of attachment is adequate enough to withstand vibrations from an earthquake without breaking or detaching. A selection of different beam deflecting devices may be attached according to the required angle of deflection. The beam deflecting device may be inverted to alter the direction of beam deflection. A plurality of incompatible clip-on means may be used to ensure that only valid combinations of antenna and deflection means can be implemented. The deflecting device or means of diverting a beam of the wireless node may be attached in front of a desired antenna of the node without the use of tools.

In an aspect of the present invention, there is provided an antenna for a communications system, wherein the antenna is housed in a radome and the antenna is configured to transmit and/or receive a beam for communications; at least one beam deflector is attached to an external portion of the radome, and the or each beam deflector is located and arranged to deflect a beam transmitted and/or received at the antenna.

Advantageously, this provides a means to readily direct a beam as desired to a desired antenna of a node. The means may be added, swapped and/or removed without damage or modification to the antenna or radome.

The at least one beam deflector may be detachably attached to the external portion of the radome. The or each beam deflector may have a shape defined by a predetermined deflection angle of a beam to be provided by the or each beam deflector. The or each beam deflector may deflect the beam and shape the beam. The or each beam deflector that deflects the beam and shapes the beam may comprise a plurality of sections that each deflect a portion of the beam by a different angle. The sections may have a dimension that is a small portion of the beam's wavelength, such as 1/10th or less of the beam's wavelength or 1/20th or less of the beam's wavelength. The or each of the beam deflectors that deflects the beam and shapes the beam may comprise a plurality of sections, such as between 50 and 150 sections, for example 100 sections, that each deflect the beam by a different angle of increasing angle across the beam deflector. The shaping of the beam may comprise broadening a transmitted beam and narrowing a received beam. The or each beam deflector may be located in a housing. The or each beam deflector may be detachably located in the housing. In this way, the beam deflection angle may be readily changed. The housing may comprise an insert configured to inhibit water ingress into the housing. This prevents damage to the beam deflector, particularly when the water freezes. The housing and a portion of the radome may comprise complementary features such that the or each beam deflector may be detachably attached to the radome. The or each beam deflector may be detachably attached to the radome by a clip arrangement. The complementary features may comprise projecting portions and a channel complementary to the projecting portions; and grooves in the radome spaced from the channel and other projecting portions. The complementary features may comprise a lug and a hole complementary to the lug, or a channel into which part of the housing fits to secure the housing in place on the radome. This arrangement is particularly easy to fit to and remove from the radome. Different complementary features may be provided such that one type of beam deflector can only be detachably attached in one or more predetermined position. In this way, certain beam deflectors may only be fitted to certain predetermined positions of the node. For example, if the node comprises antennas arranged in two layers in alternate upper and lower layers. The complementary features may comprise one type of beam deflector with a hole that can only be detachably attached to particular lugs of the radome.

The lugs may be located around a band projecting from the outer circumference of the radome. The or each housing may be resilient such that the beam deflector is detachably attached to the node by bending the housing. Advantageously, this enables the housing to be readily attached and subsequently detached from the node. The beam deflector may comprise an anti-reflection surface facing the antenna. The surface may comprise a corrugated surface. Corrugations of the corrugated surface may have a depth of half of the operating wavelength of the antenna. Advantageously, this reduces mismatch reflection in the interaction between the beam deflector and the field from the antenna with which it is associated.

A node may comprise a plurality of the antennas described above in the same radome. The node may comprise antennas described above arranged in two layers. The antennas may be arranged in alternate upper and lower layers.

A beam deflector may be provided for detachably attaching to the antenna or node described above.

A kit of parts may be provided comprising a plurality of beam deflectors for detachably attaching to the antenna or node described above. A kit of parts may be provided wherein at least one of the plurality of beam deflectors is different to at least one other of the plurality of beam deflectors such that they have a different shape to provide a different predetermined deflection angle of a beam to be provided to the antenna or node. In this way, a person or user installing beam deflectors may have a selection of beam deflectors available to readily select and install to provide a desired deflection angle.

A communications system may be provided comprising a plurality of antennas or nodes described above.

In another aspect of the present invention, there is provided a method of attaching a beam deflector to a radome in which an antenna of a communications system is housed, the antenna is configured to transmit and/or receive a beam for communications, the method comprising: a user attaching a beam deflector to an external portion of the radome, such that the beam deflector is located and arranged to deflect a beam transmitted and/or received at the antenna.

The method may further comprise the user bending the beam deflector such that complementary features of the beam deflector and the node are engaged with one another to attach the beam deflector to the external portion of the radome.

The inventors of the present patent application have appreciated that by cascading two or more lenses or beam deflectors in front of an antenna that the desired beam deflection can be achieved in a more compact package than a single beam deflector. The inventors have appreciated that for larger deflection angles a more compact package is achieved by having a first single beam deflector directly in front of the antenna, for example, providing a deflection angle of 10° and a second single beam deflector located further outward from the first single beam deflector that provides, for example, a further deflection angle of 10° and also shapes the beam. Preferably, the second single beam deflector is located to capture the fringe field by increasing rotation relative to the first single bean deflector depending on the angle of deflection of the first single beam deflector increasing vertical location the further out they are located.

In another aspect of the present invention, there is provided an antenna for a communications system, wherein the antenna is configured to transmit and/or receive a beam for communications; at least two beam deflectors are located and arranged in front of the antenna to together deflect and shape a beam transmitted and/or received at the antenna.

The at least two deflectors may be located and arranged such that the beam passes through the at least two deflectors in turn. The at least two deflectors may be located along a common axis. At least one of the beam deflectors may deflect the beam by a predetermined angle. The at least one of the beam deflectors that deflects the beam by a predetermined angle may be wedge shaped. The predetermined angle may be between 10° and 20°. At least one of the beam deflectors may deflect the beam and shape the beam. Each of the beam deflectors that deflects the beam and shapes the beam may comprise a plurality of sections that each deflect a portion of the beam by a different angle. The sections may have a dimension that is a small portion of the beam's wavelength, such as 1/10th or less of the beam's wavelength or 1/20th or less of the beam's wavelength.

Each of the beam deflectors that deflects the beam and shapes the beam may comprise a plurality of sections, such as between 50 and 150 sections, for example 100 sections, that each deflect the beam by a different angle of increasing angle across the beam deflector. The shaping of the beam may comprise broadening a transmitted beam and narrowing a received beam. The at least one beam deflector that deflects the beam and shapes the beam may be in front of the at least one of the beam deflectors that deflects the beam by a predetermined angle. Each of the beam deflectors may comprise an anti-reflection surface facing the antenna. The surface may comprise a corrugated surface. Corrugations of the corrugated surface may have a depth of half of the operating wavelength of the antenna. The beam deflectors touch one another. The at least two deflectors may be relatively located such that one or more outer deflectors of the at least two deflectors capture, at least in part, a fringe field of the beam. The at least two deflectors may be located such that one or more outer deflectors of the at least two deflectors capture a fringe field of the beam. The one or more outer deflectors may be located increasingly vertically the further out they are located to capture the fringe field of the beam. The beam may comprise radio frequency radiation such as at 10 Ghz to 90 Ghz or at 24 GHz to 30 GHz. Two and only two deflectors may be provided. The at least two deflectors may be made from polymer, such as acrylonitrile styrene acrylate, ASA, such as Luran S757R.

A node comprising a plurality of the antennas described above in the same radome may be provided. The node may comprise antennas described above arranged in two layers. The antennas may be arranged in alternate upper and lower layers.

A communication system comprising a plurality of antenna or nodes as described above may be provided.

Features described above may be combined together as appropriate.

### BRIEF DESCRIPTION OF THE DRAWINGS

The invention will be described in more detail, by way of example, with reference to the accompanying drawings, in which:

FIG. 1 (prior art) is a perspective view from above of the internal components of a known node for a communications system comprising a plurality of nodes;

FIG. 2 (prior art) is a perspective view from above of the exterior of the known node of FIG. 1;

FIG. 3 is a schematic of nodes of the type of FIGS. 1 and 2 in use;

FIG. 4 is a perspective view from above of a node for a communications system embodying an aspect of the present invention;

FIG. 5(a) is a perspective view of a housing housing a beam deflector embodying an aspect of the present invention;

FIG. 5(b) is a schematic perspective view illustrating the beam deflector of FIG. 5(a) inside the housing;

FIG. 5(c) is a perspective view of a portion of the housing of FIG. 5(a);

FIG. 5(d) is a perspective view of a portion of the housing of FIG. 5(a);

FIG. 5(e) is a perspective view of the beam deflector housed in the housing of FIG. 5(a);

FIG. 5(f) is a perspective view of the beam deflector of FIG. 5(e) from a different view point;

FIG. 6(a) is a perspective view of another housing housing a beam deflector embodying an aspect of the present invention;

FIG. 6(b) is a schematic perspective view illustrating the beam deflector of FIG. 6(a) inside the housing;

FIG. 6(c) is a perspective view schematically illustrating the interior of the housing of FIG. 6(a);

FIG. 6(d) is a perspective view of a portion of the housing of FIG. 6(a);

FIG. 6(e) is a perspective view of a portion of the housing of FIG. 6(a);

FIG. 6(f) is a perspective view of the beam deflector housed in the housing of FIG. 6(a);

FIG. 7 is a perspective view from above of the beam deflector of FIG. 5(e).

FIG. 8(a) is a perspective view from the side of a portion of a node for a communications system embodying an aspect of the present invention;

FIG. 8(b) is a perspective view from above of the node of FIG. 8(a);

FIG. 8(c) is a perspective view from the side of a portion of the node of FIG. 8(a) with a housing of the node detached and alongside the node;

FIG. 8(d) is a perspective view from the side of a portion of the node of FIG. 8(a);

FIG. 8(e) is a perspective view from above of another portion of the node of FIG. 8(a);

FIG. 8(f) is a perspective view from below of another portion of the node of FIG. 8(a) with a detachable housing being positioned;

FIG. 8(g) is a perspective view from below of another portion of the node of FIG. 8(a), with a detachable housing being positioned;

FIG. 8(h) is a perspective view from the side of a portion of a housing for connecting to the node of FIG. 8(a);

FIG. 8(i) is a perspective view from the side of a portion of the node of FIG. 8(a);

FIG. 8(j) is a perspective view from the side of a portion of a housing for connecting to the node of FIG. 8(a); and

FIG. 8(k) is a perspective view from the side of a portion of a housing for connecting to the node of FIG. 8(a).

Like reference numerals are used to describe like features throughout the present patent application.

### DETAILED DESCRIPTION OF THE INVENTION

An example node for a communications system comprising a plurality of nodes will now be described with reference to FIGS. 4 to 7. The node provides a backhaul link as part of a network of nodes. The network of nodes use S-TDMA (Spatial Time Division Multiple Access) techniques operating in the radio frequency range of 24 to 30 GHz to form a multipoint-to-multipoint mesh to enable simple and quick deployment.

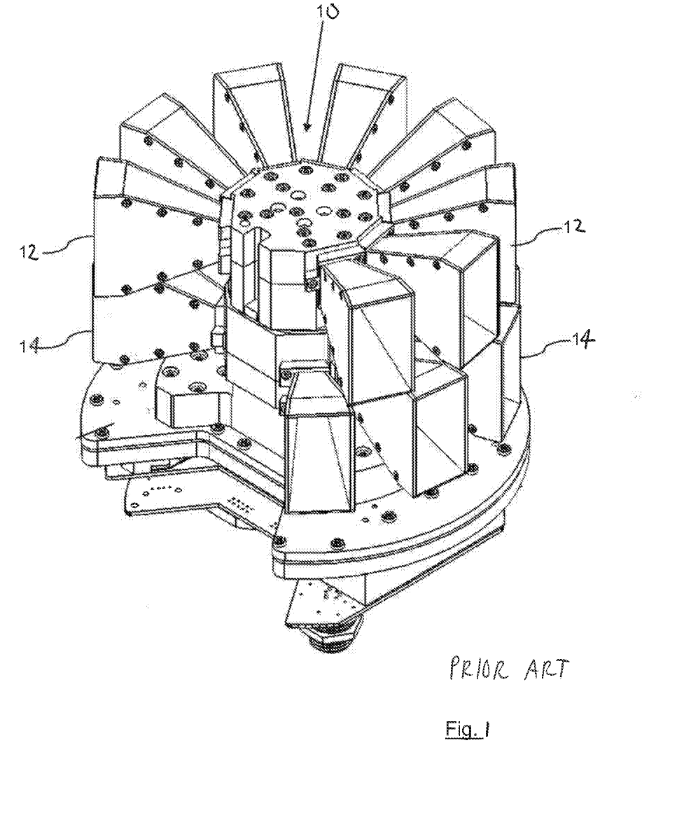

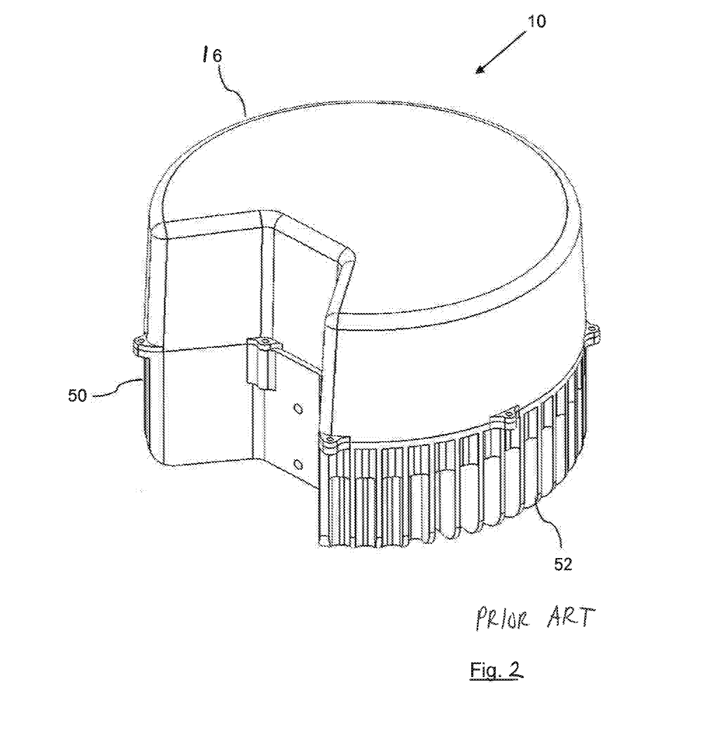

FIG. 4 illustrates the node 100 and, in particular, the outer portion including a radome 102 that is sealed. The radome is generally circularly cylindrical. Inside the radome, not visible in FIG. 4, the node includes a plurality of antennas configured to transmit and/or receive a beam for communications with other nodes of a communications system. This internal portion is the same as the known arrangement as described in UK patent application with publication No. GB2512858 and illustrated in FIG. 1 including antennas arranged in two layers with alternate antennas on upper and lower layers with a total of 16 antennas equally split between the two layers. The node further includes a beam deflector forming part of an embodiment of an aspect of the present invention, located in a housing, in this example, two beam deflectors each located in their own housing 104,106. Each beam deflector takes the form of at least one lens located and arranged to deflect a beam transmitted and/or received at the antenna with which it is associated and aligned. In the example of FIG. 4, one of the beam deflectors in housing 106 is aligned with a lower antenna of the node 100 and the other deflector in housing 104 is aligned with an upper antenna of the node (the antennas are both inside the radome and so are not visible in FIG. 4). The example of FIG. 4 includes a single lens aligned with an upper antenna and a dual lens or two lenses aligned with a lower antenna. The upper and lower antenna are adjacent antennas around the circumference of the node. This is explained in more detail further below.

Each housing 104,106 housing a beam deflector is detachably attached to the node 100. The beam deflector is detachably attached to the radome by a clip arrangement as described below. The beam deflector is detachably attached to the node 100 by the node having a pair of features that are complementary to a pair of features of the housing. One pair of complementary features takes the form of a rail, channel or band 108 around the circumference of the radome 102 with a plurality of lugs 109 projecting downwardly from the rail (in FIG. 4, for clarity, only some of the lugs have an associated reference numeral shown) and a projecting portion 110 of the housing with a through hole that is complementary in shape to the lugs of the rail. The other pair of complementary features are a through hole of the housing and a lug 112 projecting upwardly from the radome. The band may be integral or formed with the radome or a separate component added to the radome.

The radome 102 includes a plurality of lugs 112 (in FIG. 4 reference numerals are only used to indicate some of the holes for clarity) or projections around the circumference of its upper surface 114. The lugs are equally spaced apart around the circumference and number the same as the number of antennas (so, 16 in this example). The radome also includes a rail or band 108 in a lower portion 116 below the internal antennas around the circumference of the radome. Lugs 109 project downwardly from the rail and their positions and, in particular, their spacing alternate depending on whether they are aligned or associated with an upper layer antenna or a lower layer antenna.

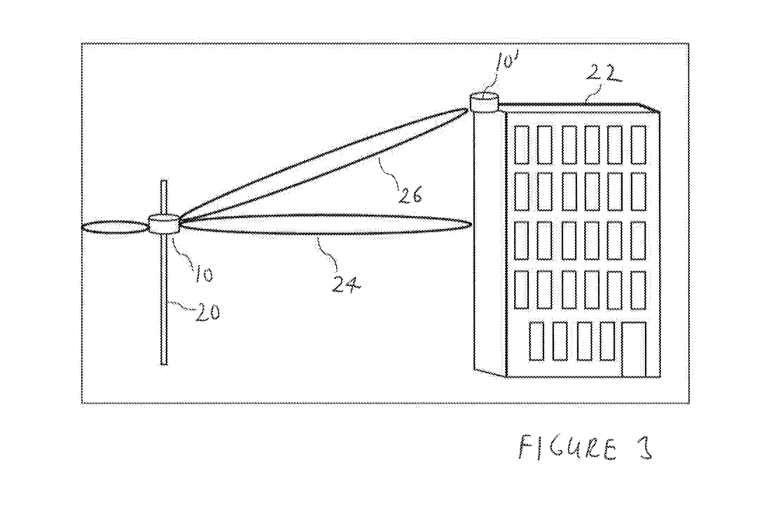

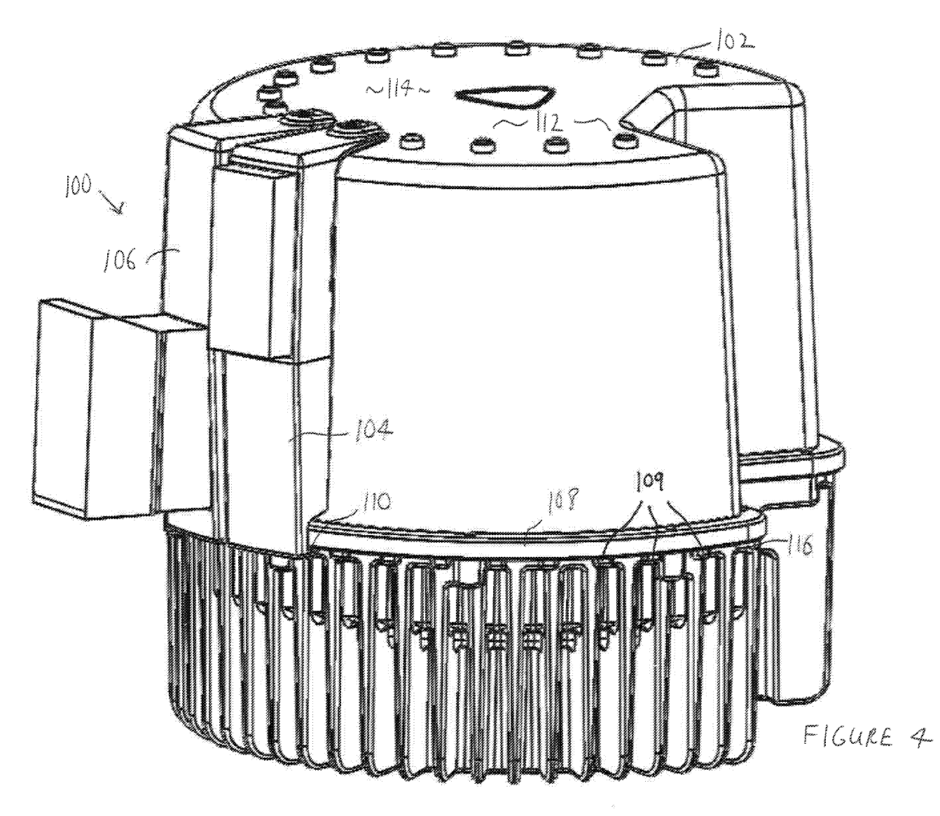

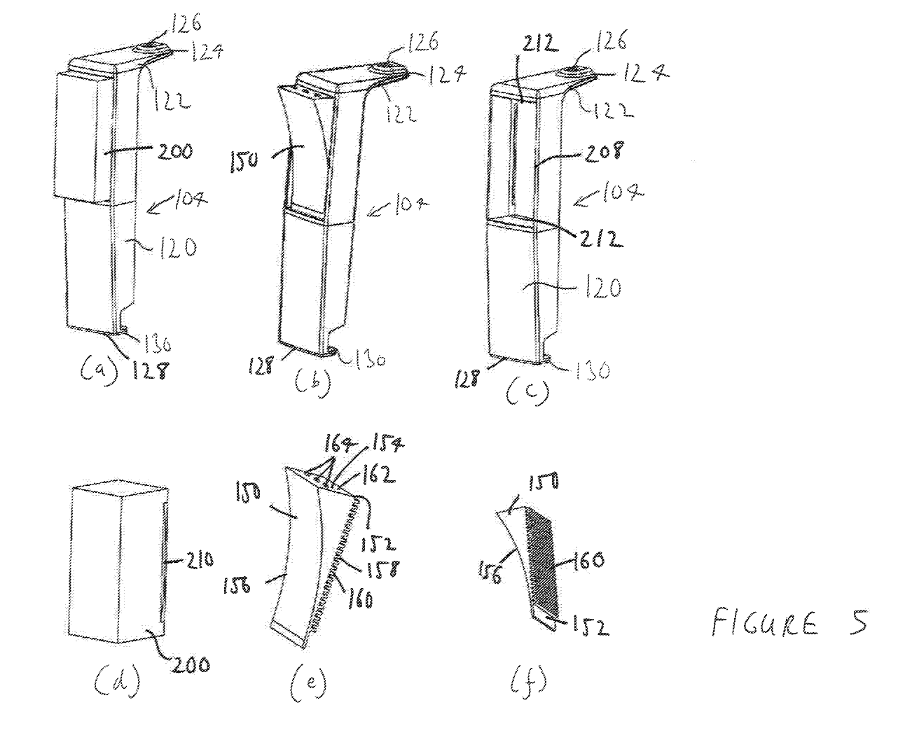

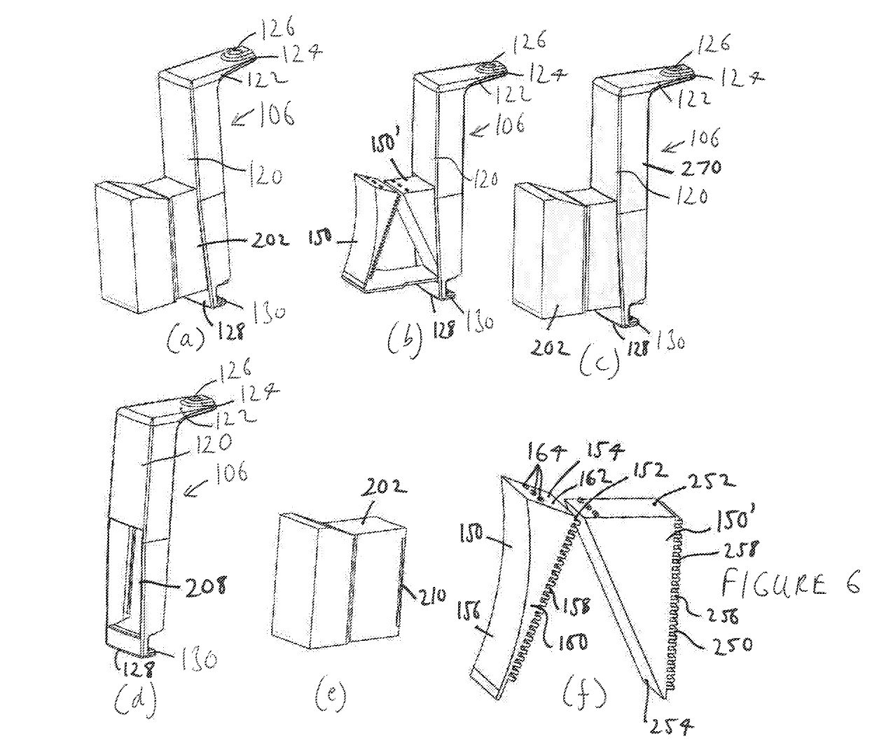

As illustrated in more detail in FIGS. 5 (a) to (c) and 6 (a) to (d), each housing 104,106 is generally L shape in cross section having a body portion 120 and an arm 122 projecting from and perpendicular to an end of the body portion. The free end 124 of the arm includes a through hole 126 through it parallel to the body. The through hole is complementary in shape to the lugs projecting from the upper surface of the radome described above. The free end 128 of the body portion includes a projecting or hook portion 130. Each projecting or hook portion includes a through hole (not shown in the Figures). The position of the through hole depends on whether the deflector of the housing is intended for an upper layer or a lower later antenna. The through hole is on one side for the housing intended for an upper antenna (FIGS. 5(a) to (c)) and on the other side for the housing intended for the lower antenna (FIGS. 6(a) to (d)). These through holes can then align with a corresponding lug on the rail of the radome. In this way, deflectors intended for upper layer antennas can only be attached or fixed in front of upper layer antennas and vice versa.

The housing 104,106 is resilient. It is elastically deformable. In use, the hole of the hook or projecting portion 130 of the housing is attached to a lug 109 of the rail 108 by a user. The housing is elastically deformed by the user such that the hole 126 of the free end 124 of the arm of the housing is also located around a lug 112 on the upper surface of the radome 102. The housing is then released by the user such that the combination of the hook attached to the rail and the lug located in the hole attach the housing to the radome. Alternatively, these operations may be reversed. The housing is removed or detached from the radome by a user elastically deforming the housing such that the hook portion of the housing is unhooked or unattached from a lug of the rail by the user and the hole of the free end 124 of the arm of the housing is removed from the lug of the upper surface of the radome. A flat bladed screw driver tip (or similar) may optionally be used to help move the upper housing edge up over the lug or securing post of the radome. Alternatively, these operations may be reversed. The user may be a person with gloved hands handling the housing with their gloved hands. Thus, in summary, the housing or lens holder is provided with a means of clipping the bottom of the lens holder over a lug below the antenna on the body of the wireless node and with a peg projecting from the upper portion or top of the radome of the wireless node which can fit into a depression or hole of the housing. The fitting of the lens holder is achieved by clipping it in place, using the natural flexibility of the plastic from which it is manufactured.

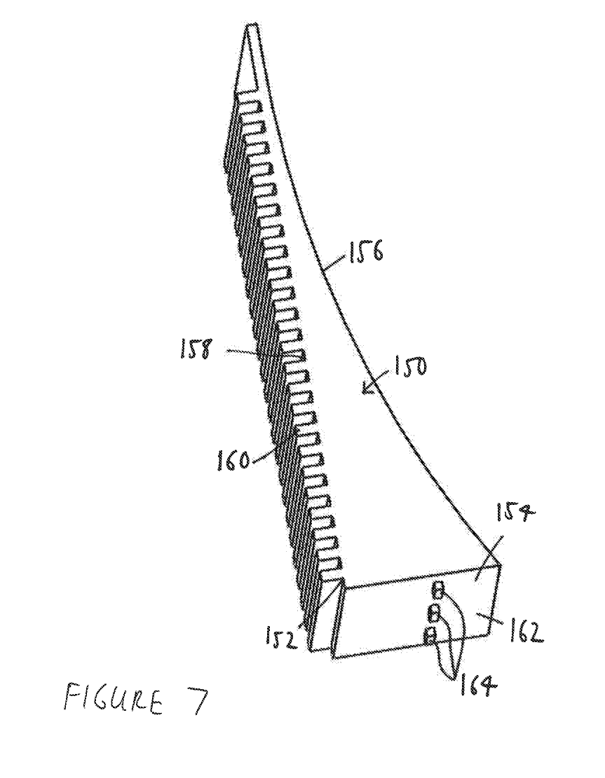

A beam deflector 150, illustrated in FIGS. 5(b),(e), and (f); and FIG. 7, is located in each housing 104,106. The beam deflector is in the form of a lens. Its shape is defined by a predetermined deflection angle required for a beam and, in particular, a radio frequency beam, to be directed from the node to a desired other node. The deflection angle is also determined by the dielectric constant of the material from which the lens is made. The beam deflector is made of plastics or polymer. In this example, the polymer is acrylonitrile styrene acrylate (ASA) and, in particular, Luran S757R. While a material of higher refractive index might be considered to result in a thinner lens for a particular desired angle of deflection, in fact, it results in a very inefficient lens. This is because for a radio frequency beam total internal reflection of a typical polymer is at a critical angle of approximately 32°. The critical angle is the angle where all of the radio frequency waves are reflected back into the lens; there is total reflection. Close to this angle much of the radio frequency beam is reflected back. Thus, in the arrangement described herein, each lens only deflects the beam by an average of 10° at the most.

Referring to FIG. 7, in particular, the lens or beam deflector 150 is broadly wedge shape. In cross section, it has a straight side 152 and an end 154 projecting perpendicular to the straight side. A deflection portion 156 curved in appearance of increasing gradient extends from the straight side to the end. The straight side forms an outer portion 158 of the beam deflector that, in use, faces away or outwardly from the node. The deflection portion that deflects a radio frequency beam and shapes the beam comprises a plurality of sections that each deflect a portion of the beam by a different angle of increasing angle across the beam deflector. In other words, the lens deflects the radio frequency beam and broadens it. In this example, there are 100 sections each of 0.5 mm width. However, other numbers of sections may be provided such as between 50 and 150 with different widths. More broadly, the sections have a dimension that is a small portion of the beam's wavelength such as 1/10th or less of the beam's wavelength or 1/20th or less of the beam's wavelength. The angle of deflection provided by each section increases by the same amount from section to section. In this example, from 0° at the narrow end to 30° at the wide end. The large number of sections gives a step size that is a small proportion of the wavelength of the radio frequency beam at 24 to 30 GHz or at 10 Ghz to 90 Ghz. In this way, it does not have an appreciable impact on artefacts provided by the lens. The purpose of the shape described is that it preserves the wave front. The effect of the plurality of lens sections is not one of independent lenses focussing many separate beams to approximate a lensing effect whilst introducing distortion. It is an aggregation effect in the far-field of parts of the radio frequency wave front being retarded relative to each other and therefore effectively smearing out the beam pattern.

This outer portion 158 acts as an anti-reflection surface. It is in the form of a corrugated surface 160 with grooves forming a castellated cross section. The grooves extend in a direction perpendicular to the straight side of the beam deflector. The grooves or corrugations of the corrugated surface have a depth of half of the operating wavelength of the antenna or, in other words, of the radio frequency beam operating at 24 to 30 GHz or at 10 Ghz to 90 Ghz.

The beam deflector 150 also includes locating features 162. The locating features are a plurality of lugs 164, in this example, three lugs. The lugs are located on the end 154 of the beam deflector towards the curved portion 156. The lugs are spaced apart along the end of the beam deflector. Each lug projects outwardly from the end of the beam deflector.

The lens or beam deflector 150 may be milled from a solid block, extruded, injection moulded or 3D printed.

Referring to FIGS. 5(a) and (d); and 6(a), (c) and (e), the lens or beam deflector 150 is located in a lens enclosure or lens box 200,202 of the housing that is detachably attached to or clipped to a portion of the housing forming a lens holder 204,206. It is located by locating features 162 to complementary features in the lens enclosure (not shown). The lens box has an outer face that has the same thickness as the wall of the radome. It is also made of the same material as the radome. This prevents reflection of the radio frequency beam. In this example, the other faces of the lens box are thinner than the outer face in order to minimise their influence on the beamshape.

Referring now to FIG. 5(c), the body of the lens holder includes a rectangular shape through hole 208. In the example of FIG. 5 (a) to (c), the through hole is located in the upper portion of the body. The lens enclosure 200 is also rectangular in plan view and complementary in shape to the through hole. The lens enclosure has flanged long edges 210. In use, the lens enclosure projects outwardly from the lens holder and the flanged long edges rest on the inner surface 212 of the body of the lens holder. The lens 150 itself is located in the lens enclosure. The outer portion 158 of the lens has the same shape as the lens enclosure and fits tightly in it.

A plurality of different lenses 150 may be provided of different shapes, allowing a range of deflection angles in a kit of parts. These may be readily inserted or changed by a user even while wearing gloves.

The beam deflector or lens 150 can be installed or adjusted in an inaccessible location in harsh weather conditions such as cold, wind and rain. It can be fitted by a single person working at height (such as up a ladder up a lamp post) with a gloved hand without tools (manual operation only) and with little manipulation. It can withstand vibrations from an earthquake without breaking or detaching.

The arrangement of FIGS. 6(a) to (f) is similar in most respects to the arrangement of FIGS. 5(a) to (f) and like features have been given like reference numerals.

The arrangement of FIGS. 5(a) to (f) provides a single beam deflector or lens to an upper antenna of the antenna array. In contrast, the arrangement of FIGS. 6(a) to (f) provides a dual beam deflector or dual lens to a lower antenna of the antenna array. By providing or cascading two lenses 150, 150′ together the deflection angle may be increased effectively in a compact arrangement. Significantly, the lens holder or housing 104,106 of both arrangements is the same except that the lens holder of FIG. 6(d) has a rectangular shape through hole 208 located in a lower portion of the body 120. The lens enclosure 202 of the example of FIGS. 6(a), (c) and (e) is slightly larger than the lens enclosure 200 of FIGS. 5(a) and (d) so that two lenses are cascaded or provided together. The lens enclosure 202 of FIGS. 6(a), (c) and (e) for two lenses projects outwardly further from the body 120 than the example of FIGS. 5(a) and (d) that houses a single lens. However, in a similar fashion to the arrangement of FIG. 5(d), the lens enclosure 202 of FIG. 6(e) is rectangular in plan view and is complementary in shape at one end to the through hole 208 of the body 120 and the lens enclosure has flanged long edges 210. In use, the lens enclosure projects outwardly from the lens holder and the flanged long edges rest on the inner surface 212 of the body of the lens holder. The lenses 150 are located in the lens enclosure one in front of the other and, in this example, in the opposite direction to the example of FIG. 5; that is to say with the end of the lenses at the lower end of the lens enclosure. The two beam deflectors 150, 150′ are located and arranged in front of the antenna to together deflect and shape a beam transmitted and/or received at the antenna. The beam passes through the two deflectors in turn. In this way, the beam from an antenna is redirected in the opposite way than that of the example of FIG. 5. The outer portion 158 of the outer lens has the same shape as the lens enclosure and fits tightly in it.

In more detail, the first lens 150′ closest to the antenna is wedge shaped. It has a back face 250 facing the antenna, a connecting face 252 projecting perpendicularly from this face and a long edge 254 extending between the back face and the connecting face. The first lens or beam deflector deflects the beam by a predetermined angle, in this example, by 10°.

The second lens 150, in front of the first lens, is the same as the lens described above with reference to FIGS. 5 and 7. The two and only two lenses or beam deflectors touch one another. The two deflectors or lenses are located along a common axis. The back face 158 of the second lens rests against an upper portion of the long edge 254 of the first lens 150′. The second lens is tilted with respect to the first lens. The two deflectors or lenses are relatively located such that outer or second deflector captures, at least in part, a fringe field of the radio frequency beam.

When more than two deflectors or lenses are used (not illustrated), they are located increasingly vertically the further out they are located to capture the fringe field of the beam.

Like the second lens 150, the first lens 150′ has an anti-reflection surface 256 facing the antenna. This takes the form of the back face 250 having a corrugated surface 258. The corrugated surface has grooves forming a castellated cross section. The grooves extend in a direction perpendicular to the longitudinal edge of the back face. The grooves or corrugations of the corrugated surface have a depth of half of the operating wavelength of the antenna or, in other words, of the radio frequency beam operating at 24 to 30 GHz.

The through hole 126 of the free end 124 of the arm 122 of the housing 106 of the example of FIGS. 6(a) to (d) is complementary in shape to the lugs 112 that project from the upper surface of the radome 102. Significantly, the through hole of the hook or projecting portion 130 of the housing is on one side of this portion, the other side to the through hole of the example of FIGS. 5(a) to (f) where the deflector is intended for an upper antenna. In this way, advantageously, a lens or lenses (upper lens or lenses) intended to be fitted to or aligned with an upper layer antenna can only be fitted to or aligned with an upper layer antenna, and a lower lens intended to be fitted to or aligned with a lower layer antenna can only be fitted to or aligned with a lower layer antenna.

As illustrated in FIG. 6(c), the housing has an insert 270 that inhibits water ingress into the housing 104,106 and thus the build-up of ice. The insert is a complementary to the unfilled space between the lens holder 204,206 and the radome. The insert is made of foam and, in particular, closed cell foam.

As illustrated above, the lenses 150,150′ may be fitted either way up with upward beam deflection being achieved in one orientation and downward beam deflection being achieved in the other orientation.

Of course, double lens enclosures may be provided to one or more upper antennas as well as lower antennas and single lens enclosures may be provided to one or more lower antennas as well as upper antennas.

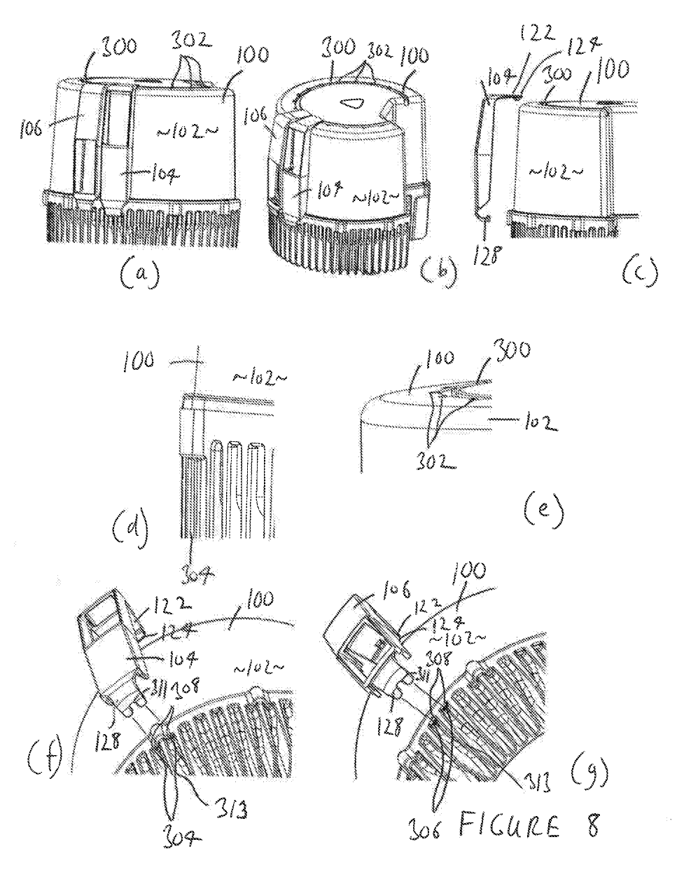

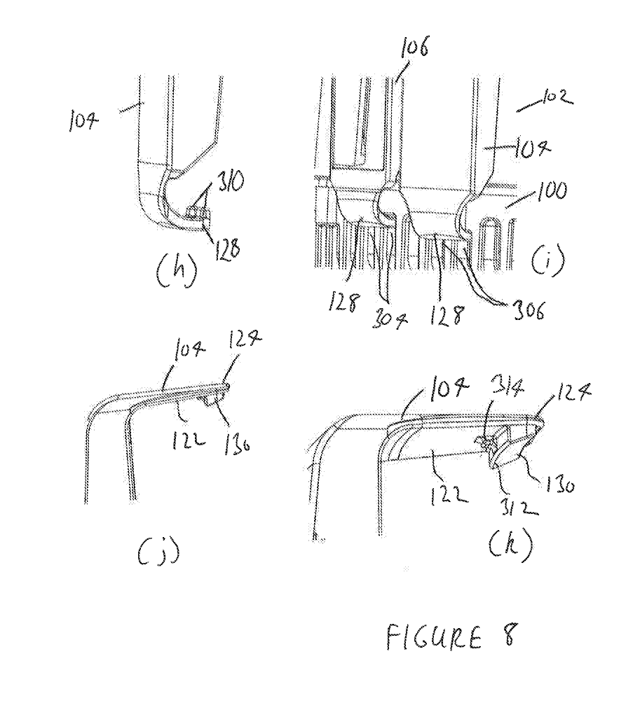

FIGS. 8(a) to (k) illustrate an alternative node 100 arrangement and housing 104,106 housing a beam deflector to detachably attach to a node 100. The arrangement is similar in most respects to the arrangement of FIGS. 4 to 7 and like features have been given like reference numerals. The differences relate to the arrangement for attaching the housing 104,106 to the node 100. The lens arrangement is the same as that of the example of FIGS. 5(a) to (f) and FIGS. 6 (a) to (f). Broadly, the arrangement for attaching the housing to the node is a trench and hook type arrangement.

The node 100 of this arrangement includes a channel 300 into which part of the housing 104,106 fits to secure the housing in place on the upper portion of the radome 102. The channel extends around the upper surface of the radome. The channel includes a plurality of notches 302 (only some of the notches have reference numerals to highlight them in FIGS. 8(a), (b), (c) and (e)) spaced apart around it and forming part of the channel. The position of each of the notches around the circumference of the radome coincides with one of the antennas of the node inside the radome. The radome also includes a plurality of grooves 304,306 that extend along the vertical axis of the node and are spaced apart around the circumference of the node. Each pair of grooves of the radome coincides with one of the antennas of the node inside the radome. The pairs of grooves 304 that coincide with an upper layer antenna terminate at a different vertical position to the pairs of grooves 306 that coincide with a lower layer antenna. In other words, the vertical position at which pairs of grooves terminate alternate around the circumference of the radome of the node. The grooves 304 coinciding with an upper layer antenna terminate lower than the grooves 306 coinciding with a lower layer antenna. In other words, shorter grooves 304 coincide with the upper layer antennas and longer grooves 306 coincide with the lower layer antennas. The grooves narrow linearly as they extend upwardly. The uppermost portion of the grooves includes an overhanging hood 308 into which the groove extends. Referring in particular to FIGS. 8(c) and (f) to (k), the housing 104, 106 includes a free end 128 with a pair of spaced apart projections 310 that are spaced apart and shaped to fit into the grooves of the radome and extend into the overhanging hoods. The portion 311 between the projections is curved to fit around the wall 313 between grooves. The other free end 128 of the body portion 104,106 includes a projecting or hook portion 130. Referring in particular to FIGS. 8(j) and (k), the hook portion includes a projecting curved portion 312 that is complementary to the portion of the channel in which it is intended to fit and a portion 314 projecting from the curved portion that is complementary to the notches 302 in the channel 300. The body portion 120 of the two types of housing 104,106 are of slightly different length such that one housing 104 can only fit in the shorter grooves 304 and the other housing 106 can only fit into the longer grooves 306.

In use, the projecting portion 130 of the housing 104,106 is attached to the channel 300 such that the projecting curved portion 312 is located in the channel and the portion 314 projecting from the curved portion is located and engaged with a notch 302 in the channel by a user. The housing is elastically deformed by the user such that the pair of spaced apart projections 310 of the other free end 128 of the housing are located in the grooves 304,306 to which the housing is sized to fit under hoods 308 at the end of the grooves.

The housing is then released by the user such that the combination of the hook portion 130 attached to the channel 300 and the spaced apart projections 310 engaging under the hood of the grooves attach the housing to the radome and only housings which are for upper layer antennas can be attached in front of upper layer antennas and vice versa. Alternatively, these operations may be reversed. The housing is removed or detached from the radome by a user elastically deforming the housing such that the hook portion of the housing is unhooked or unattached from the channel by the user and the spaced aprt projections of the housing are removed from the grooves of the radome. Alternatively, these operations may be reversed. The user may be a person with gloved hands handling the housing with their gloved hands.

Thus, in this example, the housing 104,106 and a portion of the radome 102 comprise complementary features such that the or each beam deflector is detachably attached to the radome as a clip arrangement as follows. The complementary features are the projecting portion 130 and the channel 300 complementary to the projecting portion; and grooves 304,306 in the radome spaced from the channel and other projecting portions 310.

Various components of the types described above may be provided in a kit of parts to an engineer or user for installation to nodes. This kit may include two different types of enclosure (one for single lenses and one for dual lenses). This allows for three different deflection angles by providing two different lenses. The angle of deflection can be reversed by reversing or flipping the lens or lenses in the lens holder. The lens enclosure (and the lens holder) are configured such that lens parts can be fitted or removed into any lens holder (covering upper or lower antenna element positions) while the lens holder is fitted to the radome. This allows for easy swapping between deflection angles.

The lens holder is thus configured to fit onto the radome while the radome is in place of a fully assembled node, without need for tools; provide little impact on the lens effect (such as gain and beamshape); hold the lens in adverse conditions (such as extreme temperature, vibration, and icing); enable the lens part to be fitted and removed while the lens holder is in place on the radome; and exclude water and/or ice build-up close to the lens by use of structural plastic or closed-cell foam inserts.

Embodiments of the present invention have been described. It will be appreciated that variations and modifications may be made to the described embodiments within the scope of the present invention.

1. An antenna for a communications system, wherein
the antenna is housed in a radome and the antenna is configured to transmit, receive, or transmit and receive, a beam for communications;
at least one beam deflector is attached to an external portion of the radome; and
the at least one beam deflector is located and arranged to deflect beam at the antenna.

2. An antenna according to claim 1, wherein the at least one beam deflector is detachably attached to the external portion of the radome.

3. An antenna according to claim 1, wherein the at least one beam deflector has a shape defined by a predetermined deflection angle of a beam to be provided by the at least one beam deflector.

4. An antenna according to claim 1, wherein the at least one beam deflector deflects the beam and shapes the beam.

5. An antenna according to claim 4, wherein the at least one beam deflector that deflects the beam and shapes the beam comprises a plurality of sections that each deflect a portion of the beam by a different angle.

6-8. (canceled)

9. An antenna according to claim 1, wherein the at least one beam deflector is located in a housing and the at least one beam deflector is detachably located in the housing.

10. (canceled)

11. An antenna according to claim 9, wherein the housing comprises an insert configured to inhibit water ingress into the housing.

12. An antenna according to claim 9, wherein the housing and a portion of the radome comprise complementary features such that the at least one beam deflector is detachably attached to the radome.

13. An antenna according to claim 1, wherein the at least one beam deflector is detachably attached to the radome by a clip arrangement.

14. An antenna according to claim 12, wherein the complementary features comprise projecting portions and a channel complementary to the projecting portions; and grooves in the radome spaced from the channel and other projecting portions.

15. An antenna according to claim 12, wherein the complementary features comprise a lug and a hold complementary to the lug.

16. An antenna according to claim 12, wherein different complementary features are provided such that one type of beam deflector can only be detachably attached in one or more predetermined position.

17. An antenna according to claim 15, wherein the complementary features comprise one type of beam deflector with a hole that can only be detachable attached to particular lugs of the radome.

18. An antenna according to claim 17, wherein the lugs are located around a band projecting from the outer circumference of the radome.

19. An antenna according to claim 9, wherein the at least one housing is resilient such that the beam deflector is detachably attached to the node by bending the housing.

20-25. (canceled)

26. A beam deflector for detachably attaching to the antenna or node of claim 1.

27-29. (canceled)

30. A method of attaching a beam deflector to a radome in which an antenna of a communications system is housed, the antenna is configured to transmit, receive, or transmit and receive, a beam for communications, the method comprising:
a user attaching a beam deflector to an external portion of the radome, such that the beam deflector is located and arranged to deflect the beam at the antenna.

31. A method according to claim 30, wherein the method further comprises the user bending the beam deflector such that complementary features of the beam deflector and the node are engaged with one another to attach the beam deflector to the external portion of the radome.

32. An antenna for a communications system, wherein
the antenna is configured to transmit, receive, or transmit and receive, a beam for communications; and
at least two beam deflectors are located and arranged in front of the antenna to together deflect and shape a at the antenna.

33. A node comprising a plurality of antennas of claim 17 in the same radome.
